(19) United States
(12) Patent Application Publication
(10) Pub. No.: US 2025/0270710 A1
(43) Pub. Date: Aug. 28, 2025

(54) WATER ELECTROLYSIS SYSTEM

(71) Applicant: HONDA MOTOR CO., LTD., TOKYO (JP)

(72) Inventor: Shota YUGE, WAKO-SHI (JP)

(21) Appl. No.: 19/027,803

(22) Filed: Jan. 17, 2025

(30) Foreign Application Priority Data
Feb. 26, 2024 (JP) 2024-026106

(51) Int. Cl. C25B 1/04; C25B 9/67; C25B 15/021; C25B 15/023; C25B 15/08

(52) U.S. Cl. CPC C25B 1/04; C25B 9/67; C25B 15/021; C25B 15/023; C25B 15/083; C25B 15/087

(57) ABSTRACT

A water electrolysis system includes: a water electrolysis device for electrolyzing water; a gas-liquid separator for performing gas-liquid separation of a mixed fluid of hydrogen gas and water, the mixed fluid being led out from the water electrolysis device; a dehumidifier for dehumidifying the hydrogen gas separated from the mixed fluid by the gas-liquid separator; a delivery path for delivering the hydrogen gas dehumidified by the dehumidifier; a humidifier for humidifying the hydrogen gas delivered through the delivery path; and a compression device for compressing the hydrogen gas humidified by the humidifier.

### CROSS-REFERENCE TO RELATED APPLICATIONS

This application is based upon and claims the benefit of priority from Japanese Patent Application No. 2024-026106 filed on Feb. 26, 2024, the contents of which are incorporated herein by reference.

### BACKGROUND OF THE INVENTION

### Field of the Invention

The present disclosure relates to a water electrolysis system.

### Description of the Related Art

In recent years, technological development has been conducted on power systems that contribute to energy efficiency in order to ensure that more people have access to affordable, reliable, sustainable and modern energy.

JP 2022-083098 A discloses a water electrolysis system including a water electrolysis device, a gas-liquid separator, a delivery path, and a compression device. The water electrolysis device electrolyzes water. The gas-liquid separator separates a mixed fluid of hydrogen gas and liquid water, which is led out from the water electrolysis device, into gas and liquid. The delivery path is configured to deliver the hydrogen gas separated from the mixed fluid by the gas-liquid separator. The compression device compresses the hydrogen gas guided from the delivery path.

### SUMMARY OF THE INVENTION

There has been a demand for a more satisfactory water electrolysis system.

The present invention has the object of solving the aforementioned problem.

According to an aspect of the present disclosure, there is provided a water electrolysis system comprising: a water electrolysis device configured to electrolyze water; a gas-liquid separator configured to perform gas-liquid separation of a mixed fluid of hydrogen gas and water, the mixed fluid being led out from the water electrolysis device; a dehumidifier configured to dehumidify the hydrogen gas separated from the mixed fluid by the gas-liquid separator; a delivery path configured to deliver the hydrogen gas dehumidified by the dehumidifier; a humidifier configured to humidify the hydrogen gas delivered through the delivery path; and a compression device configured to compress the hydrogen gas humidified by the humidifier.

According to the present disclosure, a more satisfactory water electrolysis system can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a water electrolysis system according to an embodiment of the present disclosure; and

FIG. 2 is a schematic configuration diagram of the water electrolysis system including a water supply unit according to a modification.

### DETAILED DESCRIPTION OF THE INVENTION

In a water electrolysis system, hydrogen gas separated from a mixed fluid by a gas-liquid separator contains water vapor. In this case, since hydrogen gas introduced into a compression device through a delivery path also contains water vapor, the electrolyte membranes constituting the compression device can be humidified by the water vapor. However, in a case where the temperature around the delivery path is relatively low, for example, condensed water may be generated in the delivery path, and the humidity of the hydrogen gas introduced into the compression device may not be appropriately controlled. Further, the delivery path may be blocked by the condensed water. The present disclosure has been made in view of such a problem, and can provide a water electrolysis system capable of suppressing the delivery path from being blocked by condensed water and also capable of appropriately controlling the humidity of hydrogen gas introduced into the compression device.

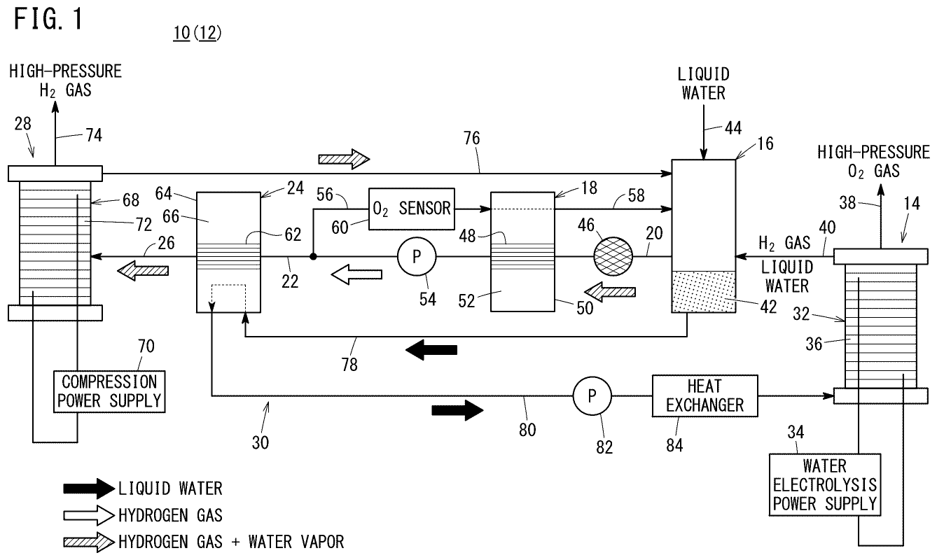

FIG. 1 is a schematic configuration diagram of a water electrolysis system 10 according to an embodiment of the present disclosure. The water electrolysis system 10 can form part of a circulative renewable energy system 12, for example. The circulative renewable energy system 12 is a system in which the water electrolysis system 10 that generates oxygen gas and hydrogen gas by electrolyzing water, and a fuel cell system that generates electricity and water by an electrochemical reaction between oxygen gas and hydrogen gas, are combined. In the circulative renewable energy system 12, the water electrolysis system 10 generates, by using water generated in the fuel cell system, oxygen gas and hydrogen gas required for power generation of the fuel cell system.

Such a circulative renewable energy system 12 can be installed, for example, on the ground or on the moon's surface. Further, the circulative renewable energy system 12 can also be mounted on a satellite such as an International Space Station (ISS). The water electrolysis system 10 is not limited to the example of being provided in the circulative renewable energy system 12, and may be provided in a hydrogen station, for example.

As shown in FIG. 1, the water electrolysis system 10 includes a water electrolysis device 14, a gas-liquid separator 16, a dehumidifier 18, a first hydrogen supply path 20, a delivery path 22, a humidifier 24, a second hydrogen supply path 26, a compression device (electrochemical compression device) 28, and a water supply unit 30.

The water electrolysis device 14 generates oxygen gas and hydrogen gas by electrolyzing water (pure water). The water electrolysis device 14 is, for example, a solid polymer water electrolysis device. The water electrolysis device 14 may be an alkaline water electrolysis device, a solid oxide water electrolysis device, or the like.

The water electrolysis device 14 includes a water electrolysis stack 32 and a water electrolysis power supply 34. The water electrolysis stack 32 includes a plurality of water electrolysis cells 36 stacked on each other. The water electrolysis power supply 34 is a DC power supply. The water electrolysis power supply 34 applies a voltage between an anode current collector and a cathode current collector of each of the water electrolysis cells 36.

The detailed illustration of the water electrolysis cells 36 will be omitted. In each of the water electrolysis cells 36, water is supplied to the cathode flow field of the water electrolysis cell 36, and the water electrolysis power supply 34 applies a voltage between the anode current collector and the cathode current collector, thereby electrolyzing water. As a result, oxygen gas is generated in the anode flow field of the water electrolysis cell 36, and hydrogen gas is generated in the cathode flow field of the water electrolysis cell 36. An ion exchange membrane of the water electrolysis cell 36 prevents the oxygen gas generated in the anode flow field from passing through to the cathode flow field. Consequently, the oxygen gas can be stored in the anode flow field, and therefore, high-pressure oxygen gas can be generated in the anode flow field.

The high-pressure oxygen gas generated in the anode flow field of each of the water electrolysis cells 36 is led out to the outside of the water electrolysis device 14 through an oxygen gas lead-out path 38. The oxygen gas lead-out path 38 guides the oxygen gas to, for example, an oxygen gas tank of the fuel cell system (not shown). The hydrogen gas generated in the cathode flow field is guided to the gas-liquid separator 16 through a hydrogen gas lead-out path 40 together with water (liquid water).

The gas-liquid separator 16 separates a mixed fluid of the hydrogen gas and the water, which is guided through the hydrogen gas lead-out path 40, into gas and liquid. The gas-liquid separator 16 includes a reservoir portion 42 for storing water (liquid water) separated from the mixed fluid. Water (liquid water) is supplied to the gas-liquid separator 16 from a water introduction path 44. For example, water generated by power generation of the fuel cell system (not shown) is guided to the water introduction path 44. It should be noted that water produced by a pure water production apparatus (not shown) may be guided to the water introduction path 44. The water stored in the reservoir portion 42 is supplied to the water electrolysis device 14 via the water supply unit 30. The detailed configuration of the water supply unit 30 will be described later. The hydrogen gas separated from the mixed fluid by the gas-liquid separator 16 contains water vapor.

The first hydrogen supply path 20 connects the gas-liquid separator 16 and the dehumidifier 18. The first hydrogen supply path 20 guides, to the dehumidifier 18, the hydrogen gas separated from the mixed fluid by the gas-liquid separator 16. A deoxygenation catalyst 46 is provided in the first hydrogen supply path 20. The deoxygenation catalyst 46 removes oxygen from the hydrogen gas. The deoxygenation catalyst 46 contains, for example, platinum.

The dehumidifier 18 dehumidifies the hydrogen gas guided from the first hydrogen supply path 20. In other words, the dehumidifier 18 dehumidifies the hydrogen gas separated from the mixed fluid by the gas-liquid separator 16. The dehumidifier 18 is a membrane dehumidifier. The membrane dehumidifier includes a plurality of hollow fiber membranes 48, and an outer tube 50 for accommodating these hollow fiber membranes 48.

Each of the hollow fiber membranes 48 is made of a material that allows water vapor to pass therethrough but does not allow hydrogen gas to pass therethrough. The hydrogen gas (containing water vapor) guided from the first hydrogen supply path 20 flows through the hollow fiber membranes 48. A dehumidifying space 52 for circulating dry hydrogen gas is formed outside the hollow fiber membranes 48. The dehumidifying space 52 is covered with the outer tube 50. In this case, the water vapor pressure inside the hollow fiber membranes 48 becomes higher than the water vapor pressure in the dehumidifying space 52, and therefore, due to the water vapor pressure difference, the water vapor contained in the hydrogen gas permeates through the hollow fiber membranes 48 and moves to the dehumidifying space 52. Consequently, the hydrogen gas is dehumidified. In such a membrane dehumidifier, the temperature change of the hydrogen gas can be suppressed as compared to a case where the hydrogen gas is dehumidified by being cooled.

The delivery path 22 is configured to deliver the hydrogen gas dehumidified by the dehumidifier 18 to the humidifier 24. The delivery path 22 is a relatively long flow path. The delivery path 22 is longer than the first hydrogen supply path 20 and the second hydrogen supply path 26. Further, the length of the delivery path 22 may be greater than the total length of the first hydrogen supply path 20 and the second hydrogen supply path 26. The delivery path 22 is provided with a hydrogen pump 54 and a branch path 56. The hydrogen pump 54 sends, toward the compression device 28 (the humidifier 24), the hydrogen gas guided from the dehumidifier 18. Therefore, it is possible to suppress the generation of condensed water in the hydrogen pump 54. The branch path 56 branches off from a portion of the delivery path 22 that is located on the downstream side of the hydrogen pump 54. Therefore, it is possible to prevent the hydrogen gas containing water vapor from flowing backward from the downstream side of the branch path 56 (the gas-liquid separator 16).

The branch path 56 guides, to the dehumidifier 18, the hydrogen gas flowing through the delivery path 22. Specifically, the branch path 56 guides the dry hydrogen gas to the dehumidifying space 52 of the dehumidifier 18. The hydrogen gas introduced from the branch path 56 into the dehumidifying space 52 is returned to the gas-liquid separator 16 through a return flow path 58 together with the water vapor (water) contained in the dehumidifying space 52. As a result, the dehumidifying space 52 can be maintained in a dry state by the dry hydrogen gas. That is, since the water vapor pressure in the dehumidifying space 52 can be made lower than the water vapor pressure inside the hollow fiber membranes 48, the hydrogen gas can be efficiently dehumidified.

The branch path 56 is provided with an oxygen sensor 60 for measuring the oxygen concentration in the dry hydrogen gas flowing through the branch path 56. In this case, it is possible to suppress the generation of condensed water in the oxygen sensor 60.

The humidifier 24 humidifies the dry hydrogen gas delivered through the delivery path 22. The humidifier 24 is a membrane humidifier. The membrane humidifier has a similar configuration to the membrane dehumidifier. That is, the membrane humidifier includes a plurality of hollow fiber membranes 62, and an outer tube 64 for accommodating the hollow fiber membranes 62.

Each of the hollow fiber membranes 62 is made of a material that allows water vapor to pass therethrough but does not allow hydrogen gas to pass therethrough. The dry hydrogen gas guided from the delivery path 22 flows through the hollow fiber membranes 62. A humidifying space 66 for circulating water vapor is formed outside the hollow fiber membranes 62. The humidifying space 66 is covered with the outer tube 64. In this case, the water vapor pressure in the humidifying space 66 becomes higher than the water vapor pressure inside the hollow fiber membranes 62, and therefore, due to the water vapor pressure difference, the water vapor in the humidifying space 66 permeates through the hollow fiber membranes 62 and moves into the hollow fiber membranes 62. Consequently, the hydrogen gas is humidified.

The second hydrogen supply path 26 connects the humidifier 24 and the compression device 28. The second hydrogen supply path 26 is configured to introduce the hydrogen gas humidified by the humidifier 24 into the compression device 28.

The compression device 28 is an electrochemical hydrogen pump that electrochemically compresses the hydrogen gas introduced from the second hydrogen supply path 26. The compression device 28 includes a compression stack 68 and a compression power supply 70. The compression stack 68 includes a plurality of compression cells 72 stacked on each other. The compression power supply 70 is a DC power supply. The compression power supply 70 applies a voltage between an anode current collector and a cathode current collector of each of the compression cells 72.

The detailed illustration of the compression cells 72 will be omitted. In each of the compression cells 72, humidified hydrogen gas is supplied to the anode flow field, and the compression power supply 70 applies a voltage between the anode current collector and the cathode current collector. Consequently, hydrogen ions are generated in the anode flow field, and the hydrogen ions pass through an ion exchange membrane of the compression cell 72 and are guided to the cathode flow field. In the cathode flow field, hydrogen ions are combined to generate hydrogen gas. The ion exchange membrane of the compression cell 72 prevents the hydrogen gas generated in the cathode flow field from passing through to the anode flow field. Consequently, the hydrogen gas can be stored in the cathode flow field, and therefore, high-pressure hydrogen gas can be generated in the cathode flow field.

The high-pressure hydrogen gas generated in the cathode flow field of each of the compression cells 72 is led out to the outside of the compression device 28 through a hydrogen gas discharge path 74. The hydrogen gas discharge path 74 guides the hydrogen gas to, for example, a hydrogen gas tank of the fuel cell system (not shown).

The water vapor contained in the hydrogen gas flowing through the anode flow field of each of the compression cells 72 humidifies the ion exchange membrane of the compression cell 72. As a result, excessive drying of the ion exchange membrane of the compression cell 72 can be suppressed. Unreacted hydrogen gas guided from the anode flow field of each of the compression cells 72 is returned to the gas-liquid separator 16 through a circulation flow path 76 together with the water vapor.

The water supply unit 30 includes a first water supply path 78, a second water supply path 80, a water pump 82, and a heat exchanger 84. The first water supply path 78 connects the gas-liquid separator 16 and the humidifier 24. The first water supply path 78 guides the water (liquid water) stored in the reservoir portion 42 of the gas-liquid separator 16, to the humidifier 24. Specifically, the first water supply path 78 guides the water to the humidifying space 66 of the humidifier 24. Water vapor can be generated in the humidifying space 66 by the water introduced from the first water supply path 78 into the humidifying space 66. As a result, since the water vapor pressure in the humidifying space 66 can be made higher than the water vapor pressure inside the hollow fiber membranes 62, the hydrogen gas can be efficiently humidified. In addition, a heating device (not shown) may be provided in the first water supply path 78. Consequently, the temperature of the hydrogen gas in the humidifying space 66 can be increased while the hydrogen gas is humidified.

The second water supply path 80 connects the humidifier 24 and the water electrolysis device 14. The second water supply path 80 guides, to the water electrolysis device 14, the water (liquid water) that has flowed through the humidifier 24. The water pump 82 is provided in the second water supply path 80. The water pump 82 sends, to the water electrolysis device 14, the water flowing through the second water supply path 80. It should be noted that the location where the water pump 82 is provided can be set as appropriate, and may be, for example, the first water supply path 78.

The heat exchanger 84 is provided in a portion of the second water supply path 80 that is located on the downstream side of the water pump 82. It should be noted that the location where the heat exchanger 84 is provided can be set as appropriate, and for example, the heat exchanger 84 may be provided in a portion of the second water supply path 80 that is located on the upstream side of the water pump 82, or may be provided in the first water supply path 78. The heat exchanger 84 adjusts the temperature of water to be supplied to the water electrolysis device 14. Consequently, water at an appropriate temperature is supplied to the water electrolysis device 14.

The water stored in the reservoir portion 42 of the gas-liquid separator 16 is circulated by the water pump 82 through the first water supply path 78, the humidifier 24, the second water supply path 80, the water electrolysis device 14, and the hydrogen gas lead-out path 40. Therefore, water whose temperature has been adjusted by the heat exchanger 84 is introduced into the humidifying space 66 of the humidifier 24. Accordingly, by using water vapor generated from the water, the humidifier 24 can adjust the temperature of the hydrogen gas to an appropriate temperature.

Next, the operation of the water electrolysis system 10 will be described. In the water electrolysis system 10, when the water pump 82 is driven, water (liquid water) stored in the reservoir portion 42 of the gas-liquid separator 16 is supplied to the water electrolysis device 14 through the first water supply path 78, the humidifier 24, and the second water supply path 80. In the water electrolysis device 14, high-pressure oxygen gas and low-pressure hydrogen gas are generated by electrolysis of the water. The high-pressure oxygen gas is guided to the outside of the water electrolysis device 14 through the oxygen gas lead-out path 38. A mixed fluid of the low-pressure hydrogen gas and the water (liquid water) is guided to the gas-liquid separator 16 through the hydrogen gas lead-out path 40.

The mixed fluid guided from the hydrogen gas lead-out path 40 to the gas-liquid separator 16 is separated into hydrogen gas (containing water vapor) and water (liquid water) by the gas-liquid separator 16. The water separated from the mixed fluid is stored in the reservoir portion 42 and reused.

The hydrogen gas separated from the mixed fluid and containing water vapor is drawn into the dehumidifier 18 by the hydrogen pump 54 through the first hydrogen supply path 20 and the deoxygenation catalyst 46. The dehumidifier 18 dehumidifies the hydrogen gas. The hydrogen gas dehumidified by the dehumidifier 18 (dry hydrogen gas) is sent to the humidifier 24 by the hydrogen pump 54 through the delivery path 22. The hydrogen gas flowing through the delivery path 22 is dry, and therefore, even in a case where the water electrolysis system 10 is operated in a low-temperature environment, for example, it is possible to suppress the generation of condensed water in the delivery path 22. The humidifier 24 appropriately humidifies the hydrogen gas and adjusts the temperature of the hydrogen gas to an appropriate temperature. The hydrogen gas that has been humidified and subjected to the temperature adjustment by the humidifier 24 is introduced into the compression device 28 through the second hydrogen supply path 26.

The compression device 28 compresses the humidified hydrogen gas. The compressed high-pressure hydrogen gas is guided to the outside of the compression device 28 through the hydrogen gas discharge path 74. The water vapor humidifies the electrolyte membranes of the compression cells 72. The hydrogen gas that has not reacted in the compression device 28 is guided to the gas-liquid separator 16 through the circulation flow path 76 together with the excess water vapor.

According to the present embodiment, the hydrogen gas separated from the mixed fluid by the gas-liquid separator 16 is dehumidified by the dehumidifier 18, and the dehumidified hydrogen gas is guided to the delivery path 22. Therefore, even when the temperature around the delivery path 22 is relatively low, it is possible to suppress the generation of condensed water inside the delivery path 22. Further, the hydrogen gas delivered through the delivery path 22 is humidified by the humidifier 24, and the humidified hydrogen gas is introduced into the compression device 28. As a result, the humidity of the hydrogen gas introduced into the compression device 28 can be appropriately controlled. Therefore, a more satisfactory water electrolysis system 10 can be provided.

### (Modification)

Next, a water supply unit 30a according to a modification will be described. In the water supply unit 30a according to the modification, the same components as those of the above-described water supply unit 30 are denoted by the same reference numerals, and the detailed description thereof will be omitted.

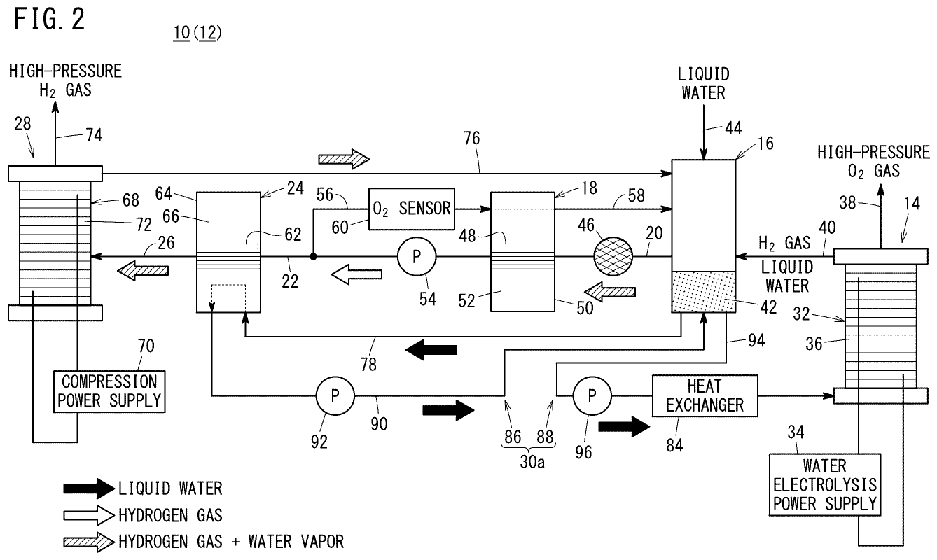

FIG. 2 is a schematic configuration diagram of the water electrolysis system 10 including the water supply unit 30a according to the modification. As shown in FIG. 2, the water supply unit 30a includes a first portion 86 for supplying water to the humidifier 24, and a second portion 88 for supplying water to the the water electrolysis device 14. The first portion 86 and the second portion 88 are separated from each other. The first portion 86 includes the first water supply path 78, a water return flow path 90, and a first water pump 92. The water return flow path 90 connects the humidifier 24 and the gas-liquid separator 16. The water return flow path 90 guides, to the gas-liquid separator 16, the water (liquid water) that has flowed through the humidifier 24. The first water pump 92 is provided in the water return flow path 90. The first water pump 92 sends, to the gas-liquid separator 16, the water flowing through the water return flow path 90. It should be noted that the location where the first water pump 92 is provided can be set as appropriate, and may be the first water supply path 78.

The second portion 88 includes a second water supply path 94, a second water pump 96, and the heat exchanger 84. The second water supply path 94 connects the gas-liquid separator 16 and the water electrolysis device 14. The second water supply path 94 guides the water stored in the reservoir portion 42 of the gas-liquid separator 16, to the water electrolysis device 14. The second water pump 96 is provided in the second water supply path 94. The second water pump 96 sends, to the water electrolysis device 14, the water flowing through the second water supply path 94.

In the present modification, the water supply unit 30a is divided into the first portion 86 for supplying water to the humidifier 24 and the second portion 88 for supplying water to the water electrolysis device 14. Further, the first portion 86 includes the first water pump 92, and the second portion 88 includes the second water pump 96. Therefore, the flow rate of the water supplied to the humidifier 24 and the flow rate of the water supplied to the water electrolysis device 14 can be individually adjusted in accordance with the operating state of the water electrolysis system 10, the ambient temperature, and the like.

The present embodiment is not limited to the configuration described above. The water electrolysis system 10 may not include the deoxygenation catalyst 46. The oxygen sensor 60 may be provided in the delivery path 22.

The following supplementary notes are further disclosed in relation to the above-described embodiment.

### Supplementary Note 1

The water electrolysis system (10) of the present disclosure includes: the water electrolysis device (14) configured to electrolyze water; the gas-liquid separator (16) configured to perform gas-liquid separation of a mixed fluid of hydrogen gas and water, the mixed fluid being led out from the water electrolysis device; the dehumidifier (18) configured to dehumidify the hydrogen gas separated from the mixed fluid by the gas-liquid separator; the delivery path (22) configured to deliver the hydrogen gas dehumidified by the dehumidifier; the humidifier (24) configured to humidify the hydrogen gas delivered through the delivery path; and the compression device (28) configured to compress the hydrogen gas humidified by the humidifier.

According to such a configuration, the hydrogen gas separated from the mixed fluid by the gas-liquid separator is dehumidified by the dehumidifier, and the dehumidified hydrogen gas is guided to the delivery path. Therefore, even when the temperature around the delivery path is relatively low, it is possible to suppress the generation of condensed water inside the delivery path. Further, the hydrogen gas delivered through the delivery path is humidified by the humidifier, and the humidified hydrogen gas is introduced into the compression device. As a result, the humidity of the hydrogen gas introduced into the compression device can be appropriately controlled. Therefore, a more satisfactory water electrolysis system can be provided.

### Supplementary Note 2

In the water electrolysis system according to Supplementary Note 1, the water obtained by dehumidifying the hydrogen gas using the dehumidifier may be guided to any of the gas-liquid separator or the humidifier.

According to such a configuration, the water obtained by dehumidifying the hydrogen gas using the dehumidifier can be reused.

### Supplementary Note 3

In the water electrolysis system according to Supplementary Note 1 or 2, the dehumidifier may be a membrane dehumidifier.

According to such a configuration, it is possible to suppress a change in the temperature of the hydrogen gas when the hydrogen gas is dehumidified.

### Supplementary Note 4

In the water electrolysis system according to any one of Supplementary Notes 1 to 3, water obtained by any of the gas-liquid separator or the dehumidifier may be guided to the humidifier.

According to such a configuration, water can be efficiently supplied to the humidifier.

### Supplementary Note 5

In the water electrolysis system according to Supplementary Note 4, the gas-liquid separator may include the reservoir portion (42) configured to store water, and the water electrolysis system may further include the water supply unit (30, 30a) configured to supply the water stored in the reservoir portion to the humidifier and the water electrolysis device.

According to such a configuration, it is not necessary to separately provide a portion for storing water to be supplied to the humidifier and a portion for storing water to be supplied to the water electrolysis device, and therefore, the configuration of the water electrolysis system can be made compact.

### Supplementary Note 6

In the water electrolysis system according to Supplementary Note 5, the water supply unit may include the heat exchanger (84) configured to adjust the temperature of the water to be supplied to the humidifier and the water electrolysis device.

According to such a configuration, the temperature of the water to be supplied to the water electrolysis device can be adjusted by the heat exchanger. As a result, the humidifier can humidify the hydrogen gas guided from the delivery path and adjust the temperature of the hydrogen gas to an appropriate temperature.

### Supplementary Note 7

In the water electrolysis system according to any one of Supplementary Notes 1 to 6, the humidifier may be a membrane humidifier.

According to such a configuration, the hydrogen gas can be efficiently humidified.

### Supplementary Note 8

In the water electrolysis system according to any one of Supplementary Notes 1 to 7, the delivery path may be provided with the pump (54) configured to send, to the compression device, the hydrogen gas guided from the dehumidifier.

According to such a configuration, since the hydrogen gas dehumidified by the dehumidifier (dry hydrogen gas) flows through the pump, it is possible to suppress the generation of condensed water in the pump. As a result, it is possible to suppress a decrease in durability of the pump due to the condensed water.

### Supplementary Note 9

The water electrolysis system according to any one of Supplementary Notes 1 to 8 may further include the oxygen sensor (60) configured to measure the oxygen concentration in the hydrogen gas flowing through the delivery path.

According to such a configuration, since the hydrogen gas dehumidified by the dehumidifier (dry hydrogen gas) flows through the oxygen sensor, it is possible to suppress the generation of condensed water in the oxygen sensor. As a result, it is possible to suppress a decrease in durability of the oxygen sensor due to the condensed water.

### Supplementary Note 10

In the water electrolysis system according to Supplementary Note 8, the delivery path may be provided with the branch path (56) that branches off from a portion of the delivery path that is located on the downstream side of the pump, and the water obtained by the dehumidifier may be returned to the gas-liquid separator by the hydrogen gas flowing through the branch path.

According to such a configuration, the water generated in the dehumidifier can be returned to the gas-liquid separator by the hydrogen gas sent from the pump and guided to the branch path. As a result, since it is not necessary to provide a new pump for returning the water generated in the dehumidifier to the gas-liquid separator, the cost of the water electrolysis system can be reduced and the size thereof can be reduced.

Although the present disclosure has been described in detail, the present disclosure is not limited to the above-described individual embodiments. Various additions, replacements, modifications, partial deletions, and the like can be made to these embodiments without departing from the gist of the present disclosure or without departing from the gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A water electrolysis system comprising:
a water electrolysis device configured to electrolyze water;
a gas-liquid separator configured to perform gas-liquid separation of a mixed fluid of hydrogen gas and water, the mixed fluid being led out from the water electrolysis device;
a dehumidifier configured to dehumidify the hydrogen gas separated from the mixed fluid by the gas-liquid separator;
a delivery path configured to deliver the hydrogen gas dehumidified by the dehumidifier;
a humidifier configured to humidify the hydrogen gas delivered through the delivery path; and
a compression device configured to compress the hydrogen gas humidified by the humidifier.

2. The water electrolysis system according to claim 1, wherein
water obtained by dehumidifying the hydrogen gas using the dehumidifier is guided to any of the gas-liquid separator or the humidifier.

3. The water electrolysis system according to claim 1, wherein
the dehumidifier is a membrane dehumidifier.

4. The water electrolysis system according to claim 1, wherein
water obtained by any of the gas-liquid separator or the dehumidifier is guided to the humidifier.

5. The water electrolysis system according to claim 4, wherein
the gas-liquid separator includes a reservoir portion configured to store water, and
the water electrolysis system further comprises a water supply unit configured to supply the water stored in the reservoir portion to the humidifier and the water electrolysis device.

6. The water electrolysis system according to claim 5, wherein
the water supply unit includes a heat exchanger configured to adjust a temperature of the water to be supplied to the humidifier and the water electrolysis device.

7. The water electrolysis system according to claim 1, wherein
the humidifier is a membrane humidifier.

8. The water electrolysis system according to claim 1, wherein
the delivery path is provided with a pump configured to send, to the compression device, the hydrogen gas guided from the dehumidifier.

9. The water electrolysis system according to claim 1, further comprising an oxygen sensor configured to measure an oxygen concentration in the hydrogen gas flowing through the delivery path.

10. The water electrolysis system according to claim 8, wherein
the delivery path is provided with a branch path that branches off from a portion of the delivery path that is located on a downstream side of the pump, and
water obtained by the dehumidifier is returned to the gas-liquid separator by the hydrogen gas flowing through the branch path.
